(19) United States
(12) Patent Application Publication
(10) Pub. No.: US 2008/0272933 A1
(43) Pub. Date: Nov. 6, 2008

(54) MOBILE UTILITY DATA COLLECTION SYSTEM

(76) Inventors: Barry Cahill-O'Brien, Spokane, WA (US); Mark K. Cornwall, Spokane, WA (US); Merita Avdagic, Pullman, WA (US)

Correspondence Address: PERKINS COIE LLP;PATENT-SEA, P.O. BOX 1247, SEATTLE, WA, 98111-1247, US

(21) Appl. No.: 12/113,869

(22) Filed: May 1, 2008

Related U.S. Application Data
(60) Provisional application No. 60/915,217, filed on May 1, 2007.

(51) Int. Cl. G08C 15/00

(52) U.S. Cl. 340/870.02

(57) ABSTRACT

Methods and systems described herein allow collection of utility system endpoint data (e.g., meter data sent by utility meters configured for automatic meter reading) via a mobile utility data collection system that includes both a remote communication portion (e.g., radio device) and an external computer portion (e.g., handheld computer with meter reading application installed).

### CROSS REFERENCE TO RELATED APPLICATION(S)

This application claims the benefit of commonly owned U.S. Provisional Patent Application No. 60/915,217, filed May 1, 2007, entitled “MOBILE UTILITY DATA COLLECTION SYSTEM,” and incorporated herein by reference in its entirety.

### BACKGROUND

Utility companies typically rely on meter reading to determine consumption of a utility by its customers. In some utility meter reading applications, operators drive vehicles equipped with radio-equipped data collection units around an area or route to read electric, gas, and/or water meters. The meters are equipped with modules that allow them to send and receive signals. This style of meter reading, sometimes referred to as mobile automatic meter reading (MAMR), allows meter reading to be completed without direct access to the meter.

MAMR is sometimes used in saturated areas where there may be large populations of meters, difficult-to-access meters, or hazardous-to-read meters. When used in such areas, MAMR can dramatically improve meter reading efficiency. For example, a single data command unit transceiver reads an average of 10,000-12,000 meters in an eight-hour shift, and can read up to 24,000 meters per day, depending on meter density and system use.

Routes for MAMR are typically defined geographically and may include hundreds or thousands of meters. The meters on the route are read using one or more techniques. For example, with a wake-up technique, a MAMR vehicle moves through an area and sends wakeup signals to notify the meters in the area to send meter reading data. With a bubble-up technique, the MAMR vehicle simply picks up broadcasted signals from all meters in its vicinity.

To determine the endpoints in a route, MAMR systems typically rely on route information provided by the utility. Typically, in advance of MAMR activities, the utility provides the MAMR system with route data consisting of lists of meter addresses. In some cases, the route information includes a list that identifies each meter using a unique meter ID and address assigned to the meter. The route information is typically formulated in advance of driving the route, and is often based on the geographic location of each meter relative to other meters in the route. For example, a MAMR route may have starting and ending points, and meters are read according to proximity from a vehicle moving between the starting and ending points.

A typical MAMR system may comprise a number of components including a radio that communicates with the various endpoints using RF. The radio may be a multi-channel radio that covers many channels at the same time and allow many endpoints to be read simultaneously. The typical MAMR system also includes an external computing device that connects to the radio and runs a meter reading application program for checking and sorting the endpoint data received by the radio. The external computing device is typically portable, as well as durable, so that it can be transported in the vehicle as part of the MAMR system. When a multi-channel radio is used, the external computing device must be fairly powerful (e.g., a Pentium class laptop computer) to handle such large amounts of data, and the communication link between the radio and the external computing device must quickly handle large volumes of information, and be reliable (e.g., a high-speed USB communications link).

In general, the typical meter reading application program collects the endpoint data received by the radio and organizes it as appropriate. This often includes eliminating duplicate readings, filtering out readings from endpoints which are not required to be read as part of the route, and storing the filtered data in a database for later use. The meter reading application may also perform two-way communication with endpoints, as well as other functions related to MAMR, such as mapping endpoints in a route, etc. In some cases, the meter reading application is comprised of modified versions of off the shelf software, such as Microsoft Windows XP and Microsoft Sequel Server database, which are installed on the external computing device.

The typical MAMR system also includes a user interface component that allows for users, such as the operator of the vehicle, to interact with the MAMR system (e.g., start and stop the system, observe the current state of the meter reading application, determine what portion of the route needs to be completed, etc.). Several aspects of the user interface component are typically incorporated into the external computing device.

As the MAMR vehicle moves quickly through the area containing the endpoints of a meter reading route, the typical MAMR radio continuously picks up a large number of messages from the endpoints on the route. These messages may also include one or more duplicates because the endpoints, which typically have no way to confirm whether their message was received by the MAMR system, may send many copies of the same message to make sure at least one makes it to the MAMR system. Because the MAMR system is bombarded with such a large number of messages during a relatively short time period, it is desirable that the meter reading application sort and process the received data as quickly as possible, to prevent the application from falling too far behind the radio receiver as the meter reading route is performed. This is especially true when a multi-channel radio is used.

These and other problems can exist with some current systems.

### BRIEF DESCRIPTION OF THE DRAWINGS

FIG. 1 is a block diagram showing an example of a system for performing mobile collection of meter reading data under one embodiment.

FIG. 2 is a block diagram showing an example implementation of the mobile data collection system of FIG. 1.

FIG. 3 is a data diagram showing and example of pre-load data provided to the radio device of the mobile data collection system of FIGS. 1 and 2.

FIG. 4 is a block diagram showing an example of data types stored in the database of the radio device of the mobile data collection system of FIGS. 1 and 2.

FIG. 5 is a flow diagram showing the handling of meter data by the mobile data collection system under one embodiment.

FIG. 6 is a flow diagram showing the handling of meter data by the mobile data collection system under one embodiment where the endpoints are configured for two-way communication.

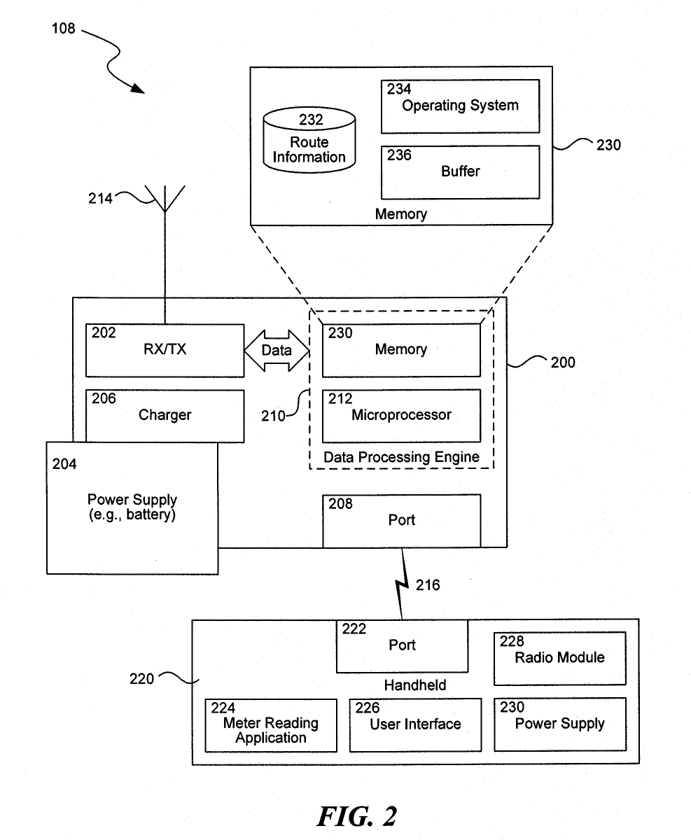

In the drawings, the same reference numbers identify identical or substantially similar elements or acts. To facilitate the discussion of any particular element or act, the most significant digit or digits in a reference number refer to the figure number in which that element is first introduced (e.g., element 204 is first introduced and discussed with respect to FIG. 2).

### DETAILED DESCRIPTION

The invention will now be described with respect to various embodiments. The following description provides specific details for a thorough understanding of, and enabling description for, these embodiments of the invention. However, one skilled in the art will understand that the invention may be practiced without these details. In other instances, well-known structures and functions have not been shown or described in detail to avoid unnecessarily obscuring the description of the embodiments of the invention.

It is intended that the terminology used in the description presented be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

### I. Overview

The methods and systems described herein allow collection of utility system endpoint data (e.g., meter data sent by utility meters configured for automatic meter reading) via a mobile utility data collection system that includes both a remote communication portion (e.g., radio device) and an external computer portion (e.g., handheld computer with meter reading application installed). The remote communication portion (e.g., radio device) of the mobile utility data collection system includes a data processing engine comprising, for example, data storage capabilities (e.g., a database for storing endpoint information and other information) and data filtering functionality (e.g., for sorting and filtering incoming data from various endpoints on a meter reading route). This configuration minimizes the amount of data sent to the external computer portion (e.g., handheld computer with meter reading application installed) for processing, as the remote communication portion otherwise bears the burden of various time dependent tasks that have, in traditional systems, been performed by the external computer portion of mobile utility data collection systems. For example, the remote communication portion may handle filtering out duplicate messages sent by endpoints, thus dramatically reducing the number of messages passed on to the meter reading application running in the external computer portion.

With the configuration described above, and in other embodiments of the system, it becomes feasible to use a less powerful external computer portion and a less robust communication link between the external computer portion and the remote communication portion, thereby reducing the cost and improving the adaptability of the mobile utility data collection system. For example, the need for an expensive laptop with a high amount of processing power is diminished and less-sophisticated handheld device can be used in its place. In another example, a more powerful external computer may still be utilized, but its resources are freed, allowing it to perform other functionality (e.g., advanced route mapping).

In one example of a mobile utility data collection system, a radio device located on a mobile data collection vehicle includes an endpoint information database that can be configured prior to starting a meter reading route. The database, when used in conjunction with filtering and sorting functionality associated with the radio device, facilitates filtering and sorting of a potentially large amount of meter data received by the radio device. The radio device then passes the sorted and filtered information on to a meter reading application running on a handheld computer, which may also be located on the mobile data collection vehicle, along with the radio device. In this example, the interface between the radio device and the handheld may be handled primarily by the radio device, as opposed to the handheld. The radio device can also be configured to support real-time functionality that allows it to support more sophisticated endpoints (e.g., those having two-way functionality).

In another example of a mobile utility data collection system, the handheld device is coupled to a radio device during mobile reading, such as is described in the above example and then disconnected and used while performing manual meter reads within a route. In yet another example, the handheld can be used to perform data collection from meters/endpoints that require external probing such as TOU or demand meters. In another example, the handheld may house its own radio module for use in interrogating MAMR meters that cannot be accessed from the MAMR radio (e.g., due to interference or a hard to read location). In this case, the handheld would be unlinked from the radio and the internal radio module would be used to perform the read. With a handheld that operates in both a MAMR and a manual mode, the switch between modes may happen automatically (e.g., depending on the presence of a link between the radio and the handheld).

### II. Representative System

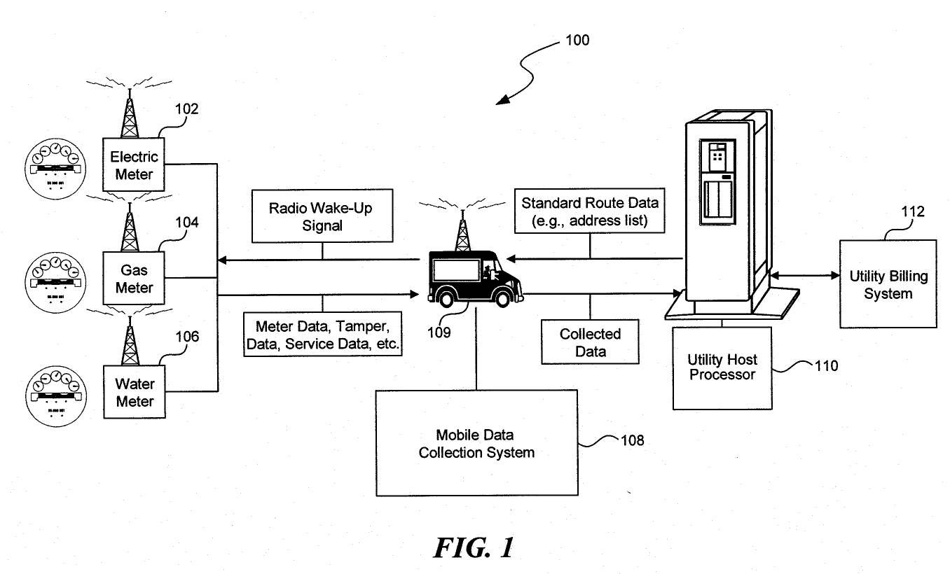

FIG. 1 and the following discussion provide a brief, general description of a suitable environment in which the invention can be implemented. Although not required, aspects of the invention are described in the general context of computer-executable instructions, such as routines executed by a general-purpose computer (e.g., a server computer, wireless device, or personal/laptop computer). Those skilled in the relevant art will appreciate that the invention can be practiced with other communications, data processing, or computer system configurations, including Internet appliances, hand-held devices (including personal digital assistants (PDAs)), wearable computers, all manner of cellular or mobile phones, embedded computers (including those coupled to vehicles), multi-processor systems, microprocessor-based or programmable consumer electronics, set-top boxes, network PCs, mini-computers, mainframe computers, and the like. Indeed, the terms “computer,” “host,” and “host computer” are generally used interchangeably and refer to any of the above devices and systems, as well as any data processor.

Aspects of the invention can be embodied in a special purpose computer or data processor that is specifically programmed, configured, or constructed to perform one or more of the computer-executable instructions explained in detail herein. Aspects of the invention can also be practiced in distributed computing environments where tasks or modules are performed by remote processing devices, which are linked through a communication network. In a distributed computing environment, program modules may be located in both local and remote memory storage devices.

Aspects of the invention may be stored or distributed on computer-readable media, including magnetically or optically readable computer disks, as microcode on semiconductor memory, nanotechnology memory, organic or optical memory, or other portable data storage media. Indeed, computer-implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or may be provided on any analog or digital network (packet switched, circuit switched, or other scheme). Those skilled in the relevant art will recognize that portions of the invention reside on a server computer, while corresponding portions reside on a client computer, such as a mobile device.

Referring to FIG. 1, a mobile automatic meter reading (MAMR) system 100 provides various components. The system 100 is an example of one arrangement of elements, but others are possible. The system 100 includes a collection of utility meters (102, 104, and 106). The utility meters may be of the same or different types (e.g., electric 102, gas 104, water 106, or other (not shown)). The utility meters (102, 104, and 106) may be distributed in a bounded or unbounded geographical area. Each utility meter (102, 104, or 106) is connected to or associated with a utility consuming facility (not shown). For example, a utility meter may correspond with a household, a commercial facility, or another utility consuming facility or device.

While not illustrated in detail, each meter (102, 104, or 106) includes a storage component (not shown) for storing collected data before transmission to a data collection system. The storage component may also store information identifying the meter, such as a meter address. In addition, each meter may be configured with a receiver/transmitter telemetry device (e.g., ERT) capable of sending and, if configured for two-way communication, receiving signals to and/or from a mobile data collection system 108. In general, these components (meter, storage, and telemetry device) may be collectively referred to as an “endpoint.” However, the term “endpoint” may herein refer to any one of a number of possible configurations for locally collecting data, such as utility consumption data, and not only the sample configuration described above.

In some embodiments, the mobile data collection system 108, which is described in more detail with respect to FIG. 2, may send a wake-up signal to an endpoint. The received wake-up signal prompts the endpoint to transmit meter reading data to the mobile data collection system 108. In alternative embodiments, “bubble-up” (broadcast) techniques may be used instead of the “wake-up” technique described above. In yet other embodiments, the mobile data collection system 108 may be capable of point-to-point communications with specific endpoints. To facilitate MAMR or similar techniques, the mobile data collection system 108 may be installed in a vehicle 109 or be otherwise configured to be transported through a route. For example, the vehicle may include the appropriate antennas, power cables, mounts, etc.

The system 100 also includes a utility host processing system 110. The host processing system 110 may be operating in association with systems operated by a utility company, such as a utility billing system 112 or, more generally, a customer information system (CIS). In this way, the host processing system communicates information to the data collection system 108. This information may include standard route data.

Referring to FIG. 2, the mobile data collection system 108 of FIG. 1 is shown in more detail. The mobile data collection system 108 includes both a remote communication portion, illustrated in FIG. 2 as radio device 200, and an external computer portion, illustrated in FIG. 2 as a handheld device 220. The radio device 200 may be relatively high-powered (e.g., operating in the 5-10 watt range for transmit power), thereby allowing it to communicate with endpoints that are located at a distance from the vehicle carrying the mobile data collection system 108 during a meter reading route.

The radio device 200 includes a receiver and/or transmitter component (RX/TX) 202 and antenna 214. In some embodiments, radio device 200 uses the receiver and/or transmitter component 202 and antenna 214 to send signals to wake-up endpoints/meters that function in “wake-up” mode and to receive incoming data. Other modes of operation are also possible. While not shown, the radio device 200 may be configured to work with a Global Positioning System (GPS) component, a Global Information Services (GIS) component, or like systems, which may be used to facilitate mapping and other related functionality, such as route playback features, as described in commonly owned U.S. patent application Ser. No. 10/903,866, filed on Jul. 39, 2004, entitled “MAPPING IN MOBILE DATA COLLECTION SYSTEMS, SUCH AS FOR UTILITY METER READING AND RELATED APPLICATIONS.”

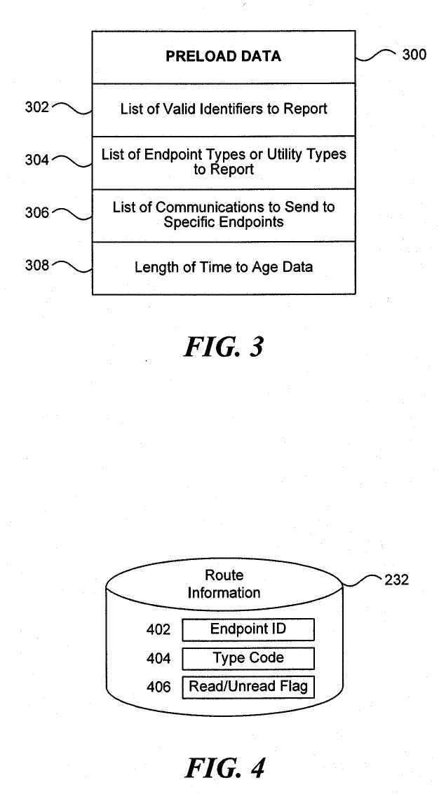

The radio device 200, in addition to communicating with endpoints via the RX/TX component 202 and antenna 214, performs initial processing of received meter data via a data processing engine 210. The data processing engine 210 includes a memory 230 and a microprocessor 212. The memory 230 of the data processing engine 210 may include a buffer 236 (e.g., for buffering data to later be sent to the handheld when the serial link is slow). The memory 230 may also include at least one database 232 for storing various types of information. As shown in FIG. 3, this information may include, generally, preload information 300 (e.g., information needed to perform reads of a meter reading route) and, more particularly, information such as a list of valid endpoint identifiers 302, a list of endpoint types or utility types 304, a list of communications of messages/frequencies/codes to send to specific endpoints (for 2-way communications) 306, a length of time to age the data 308 so updated values from prior read endpoints are reported again, etc.

The database 232 may also store information that is collected while performing or traversing a route (e.g., meter reads, GPS data, any additional data from the endpoint, etc.), as well as other relevant information (e.g., data regarding the condition of the vehicle or route, operating temperature, general status information diagnostic data (e.g., number of times a given meter is read in a route) log files, information regarding the radio link such as return signal strength indicator (RSSI) levels, signal-to-noise ratio, etc.).

FIG. 4 illustrates various examples of data types 400 used in the database 232 while performing a route including endpoint ID 402, and optionally a type code 404, as well as a flag 406 indicating whether or not the endpoint has previously been read on that route. The database 232 may be constructed so that its records are arranged for efficiency in reading. The database 232 may utilize data optimization techniques, etc., for performing searching and querying. In an alternative embodiment, no database is pre-stored in the radio, but instead the radio builds it as it reads endpoints in a route and/or looks for duplicates endpoint reads.

In general, the memory 230 facilitating the one or more databases 232 is fairly robust (e.g., at least one megabyte). In some embodiments, if the memory 230 is large enough, it may include, for example, a permanent database of all the endpoints within a region, and thus only require new endpoints to be added as they are created. Otherwise, the database 232 may need updating more frequently (e.g., at the beginning of each day or each time a new route is to be performed). While not shown, a CD ROM drive (and or other drive) may read/write removable media, such as for importing new preloaded information prior to performing a route. Alternatively, in some embodiments, information may be transferred to and from the radio device 200 using a removable flash card (not shown). For example, an operating system 234 of the radio device 200 may recognize the flash card as a removable drive, allowing standard file access. In other embodiments, the routes may be transferred to the radio device 200 via a local area network (LAN), a wide area network (WAN), etc. In some embodiments, the endpoint information that populates the database is downloaded to the radio device daily, but it could also be weekly or monthly, or as noted above, include a large enough database to include every endpoint in all routes.

The data processing engine 210 may perform various data management functions, such as sorting and filtering incoming data from various endpoints on a meter reading route. Accordingly, the microprocessor 212 associated with the data processing engine 210 is most likely “laptop size” so that it can perform the data management functions described above, as well as Digital Signal Processing (DSP) as needed to operate the radio appropriately. While a microprocessor is preferred, the system could also use an application specific integrated circuit (ASIC), dedicated logic such as a DSP, etc. The data processing engine 210 allows the radio to bear the burden of various time dependent tasks that have in the past been performed by the external computer portion of traditional mobile utility data collection systems. For example, the data processing engine may handle filtering out duplicate messages sent by endpoints, thus dramatically reducing the number of messages passed on to a meter reading application 224 running in the handheld 220. The radio device 200 may also include a power supply 204 and charger 206.

In general, the handheld device 220 is configured to receive meter information from the radio device 200 after it has been filtered through the data processing engine 210. Examples of functions performed by the meter reading application 224 include maintaining route-related meter reading statistics, providing operating status information, and processing, formatting, and displaying collected data. The meter reading application 224 may also include administrative functionality that administrative users can use to control preferences and settings of the data collection system. Examples of meter reading applications may include MV-RS™, Premierplus4™, Viena™, and Integrator™, all by Itron, Inc. of Liberty Lake, Wash. User interaction with the meter reading application, is facilitated via a user interface 226, which may also be configured to control aspects of the radio device 200 alternatively, the radio device 200 may have its own user interface component (not show). In general, a user interface(s) associated with the mobile collection system 108 may provide various features for ease of use, such as a color touch screen and clear graphical mapping displays. Other user input/output options may be used including mouses, microphones, speakers, joysticks, keyboards, LCD screens, audio, etc. Indeed, the handheld device can include other components (not shown) such as a processor, memory, etc. Further, the memory can store the route information, and may include information on the geographic route to traverse, in addition to endpoint IDs, type codes, etc.

The handheld device 220 is coupled to the radio device 200 via a communication link 216 during mobile reading, but may later be disconnected so that the handheld device 220 can independently be used, for example, to perform manual meter reads within a route. In some embodiments, the handheld device 220 can be used to perform data collection from meters/endpoints that require external probing such as TOU or demand meters. Along similar lines, the handheld device 220 may house its own radio module 228 for use in interrogating MAMR meters that cannot be accessed using the radio device 200 in the vehicle (e.g., due to interference or a hard to read location). In such cases, the handheld device 220 is unlinked from the radio device 200 and the internal radio module in the handheld device 220 is used to perform the read. With a handheld device 220 that operates in both a MAMR and a manual mode, the switch between modes may happen automatically (e.g., depending on whether the presence of a communication link between the radio and the handheld). Alternatively, the handheld device 220 may provide, through its user interface 226, one or more screens that allow the user to switch between a handheld mode and a mobile collector mode. Of course, a hardware switch could also be provided.

If it does include its own radio module 228, the handheld device 220, when compared with the radio device 200, is a relatively low-power device (e.g., at approximately a quarter watt of transmit power) and may be powered by a fairly small battery or other power supply 230. While not shown, the mobile collection system 108 may also include a charger for charging the handheld device 220. To preserve battery life, the radio module 228 in the handheld device 220 may be only selectively turned on for performing reads. Furthermore, the handheld device 220 may include a switch to turn on the radio when the handheld is removed from a holster, socket or releasable mount in the vehicle.

Communication between the handheld 220 and the radio 200 may occur via communication link 216 between their respective ports, 222 and 208. The communication link 216 may be of any type including wired or wireless. A high-speed or high-capacity connection is not required because the configuration of the mobile collection system 108 is designed to decrease the amount of information that the handheld device 220 is to receive from the radio device 200. Accordingly, the use of standard serial ports is acceptable, as is the use of wireless communication links such as Bluetooth and IEEE 802.11.

### III. System Flows

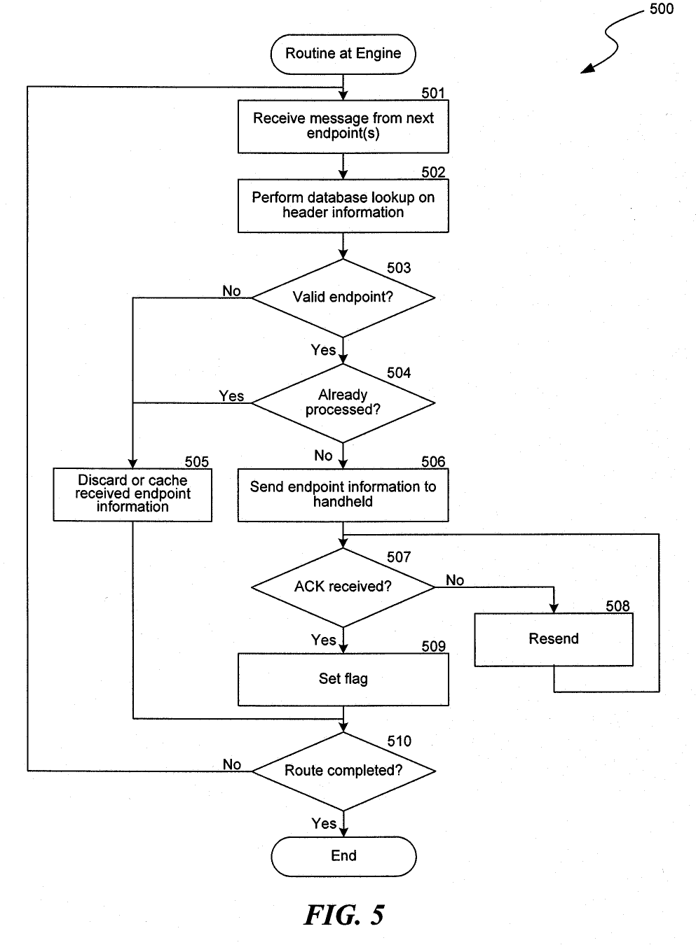

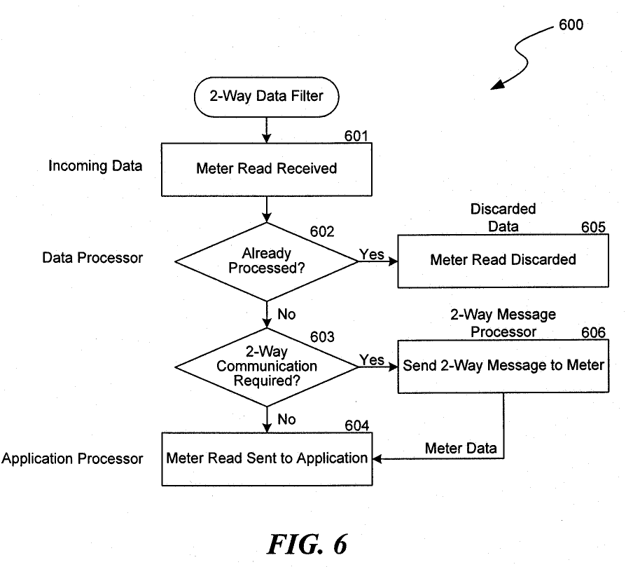

FIGS. 5 and 6 are representative flow diagrams that show processes that occur within the system of FIG. 1. These flow diagrams do not show all functions or exchanges of data but, instead, provide an understanding of commands and data exchanged under the system. Those skilled in the relevant art will recognize that some functions or exchanges of commands and data may be repeated, varied, omitted, or supplemented, and other aspects not shown may be readily implemented. For example, while not described in detail, a message containing data may be transmitted through a message queue, over HTTP, etc. In general, as the radio receives data packets, they are first processed by the data processor in the radio. Only the data which passes through this processor is sent to the application processor in the handheld device. The remaining data is discarded or cached.

Referring to FIG. 5, a routine 500 is performed by the data processing engine of the radio device to process incoming messages received from endpoints while performing a meter reading route. In the illustrated embodiment, the routine 500 is repeated for each incoming message, but alternative implementations are possible (e.g. performing processing on groups of incoming messages, etc.) The routine 500 begins at block 501, where the routine 500 receives a message from an endpoint.

At block 502, the routine 500 performs a database lookup on header information from the message to determine, at decision block 503, if the endpoint is a valid endpoint (e.g., it is part of the route, of the appropriate type, etc.) and to determine, at decision block 504 if a read for that endpoint has already been processed during the route (i.e., a duplicate). If the endpoint is not valid or if the endpoint is a duplicate that has already been processed, the routine 500 continues at block 505, where the routine 500 either discards or caches the received endpoint information. In some embodiments, caching may be performed to gather information about out of route reads as is described in commonly owned U.S. patent application Ser. No. 10/903,866, filed on Jul. 39, 2004, entitled “MAPPING IN MOBILE DATA COLLECTION SYSTEMS, SUCH AS FOR UTILITY METER READING AND RELATED APPLICATIONS.” Otherwise the routine 500 continues at block 506, where the routine 500 sends/forwards the endpoint information to the handheld device. While not illustrated as part of the routine 500, the data processing engine may first format the endpoint information before sending it to the handheld, or may alternatively send a copy of the raw message. In some cases, the formatting of the message may include grouping it with other received messages.

At block 507 the routine 500 checks whether it has received an acknowledgement (ACK) message from the handheld confirming that the handheld has received the endpoint information sent at block 506. If an ACK is not received, the routine 500 may resend the message (block 508) before looping back to decision block 507. While not illustrated in the flow chart, in some embodiments, the routine 500 may continue to process incoming messages (e.g., blocks 501 through 506) while waiting for an ACK from the handheld. Once an ACK is received from the handheld, the routine 500 continues at block 509 where a flag is set indicating that the endpoint has been read and that the information has successfully been sent to the handheld. In other words, the data processing engine in the radio can confirm the arrival of incoming data at the meter reading application in the handheld, thus eliminating the need for the data processing engine to send multiple messages to the handheld. As the data processing engine confirms the delivery of every message to the handheld, the handheld does not have to expend resources to keep up in real time with the radio. This makes the handheld device more tolerant of “off the shelf” software, which is typically not designed to have highly deterministic timing. At decision block 510 the routine 500 checks to see whether the route is complete. If not, the routine loops back to block 501 to read the next endpoint.

Typically, a single endpoint will be read ten to fifteen times by a receiver during a route. Having the radio perform preprocessing reduces the amount of information processed by the meter reading application in the handheld by a factor of at least ten. In some embodiments, if the radio receives a later reading that is more current than a previously-received reading (e.g., outside of a several second or less window), then that may be kept, and the previous reading possibly discarded. This could be relevant for commercial/industrial customers when the reader passes by later in the day that same endpoint.

In some embodiments, two-way communication with endpoints may be possible. An example of a simplified routine 600 for handling two-way communication at the data processing engine of the radio is shown in FIG. 6. The data processing engine in the radio may store and manage the data that is to be sent to the endpoints, thus reducing the need to have the application on the handheld device constantly ready and available for two-way communication. At block 601, the routine 600 may initially send out a wake-up message, and then the routine 600 receives meter read information from an endpoint. At decision block 602, the routine 600 checks if the message is a duplicate (already been processed). If the message is a duplicate, it is discarded at block 605. If the message has not already been processed, the routine 600 proceeds at decision block 603 where the routine 600 checks whether additional two-way communication is required (e.g., by default, by performing a database lookup, or by checking the information in the message itself). If two-way communications is required, the routine 600 continues at block 606 to send the appropriate two-way message to the meter, which may involve an internal database lookup and, in some cases, a communication with the application on the handheld device. At block 604 the routine 600 sends the meter read to the meter reading application in the handheld.

### IV. Conclusion

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while illustrated in terms of a MAMR technology, several of the techniques described above may be utilized for fixed-network automatic meter reading (AMR). In another example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times. Where the context permits, words in the above Detailed Description using the singular or plural number may also include the plural or singular number, respectively. The teachings of the invention provided herein can be applied to other systems, not necessarily the system described herein. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the mobile utility data collection system may vary considerably in their implementation details, while still be encompassed by the invention disclosed herein. As noted above, particular terminology used when describing certain features or aspects of the invention should not be taken to imply that the terminology is being re-defined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I/We claim:

1. A system for automated data collection of utility data from multiple endpoints, wherein the utility data includes an amount consumed of a public utility such as electricity, gas or water, and wherein the endpoints include a utility meter, the system comprising:
a radio device comprising:
a radio receiver or radio transceiver, wherein the radio receives utility data wirelessly transmitted by at least some of the multiple endpoints,
first memory for storing a database of selected endpoints,
a first communications port,
at least a first processor coupled to the radio, first memory, and first communications port,
wherein the first processor is configured to perform initial processing of the received utility data,
wherein the initial processing includes comparing the received utility data to the database of selected endpoints to filter out undesired utility data and to pass certain utility data to the communications port, and
a first housing configured to at least partially hold the radio, first processor, first memory, and first communications port; and,
a handheld utility reading device comprising:
second memory for storing a meter reading application,
a second communications port coupled to receive from the first communications port the unfiltered utility data,
at least a second processor coupled to the second memory and second communications port, wherein the second processor is configured to execute the meter reading application and to process the certain utility data, and,
a second housing configured to at least partially hold the radio, processor, memory, and second communications port,
wherein the radio device and the handheld utility reading device are configured to be portable as a unit for automated data collection of the utility data from the multiple endpoints.

2. The system of claim 1 wherein the utility data includes identification values associated with the multiple endpoints, wherein the database of selected endpoints includes a list of selected identification values, and wherein the initial processing includes determining if a received utility data item corresponds to a duplicate or newer utility data item.

3. The system of claim 1 wherein the first and second communications ports are wired ports, wherein the handheld utility reading device further comprises a separate radio receiver or radio transceiver that has operates at lower power or with a narrower bandwidth as compared to the radio receiver or radio transceiver of the radio device, and wherein the handheld utility reading device is configured for independent wireless and automatic utility data collection from at least some of the multiple endpoints.

4. A method of gathering data from multiple public utility endpoints, wherein the gathered data includes an amount of a utility consumed, the method comprising:
receiving data from at least one of the public utility endpoints, wherein the data includes indicia identifying the at least one public utility endpoint, wherein the receiving occurs at a public utility data collection device when in radio communication range of the at least one public utility endpoint, and wherein the public utility data collection device includes a wireless mobile communication device and an external, portable computer;
processing the received data at the wireless mobile communication device, wherein the indicia identifying the at least one of the public utility endpoints is compared to data stored in the wireless mobile communication device; and
transferring the received data from the wireless mobile communication device to the external, portable computer if the received data succeeds the comparison.

5. The method of claim 4 wherein processing the received data at the wireless mobile communication device includes discarding the received data if utility consumption data from the at least one of the public utility endpoints has already been received.

6. The method of claim 1 wherein processing the received data at the wireless mobile communication device includes discarding the received data if utility consumption data from the at least one of the public utility endpoints has been received less than a predetermined time period earlier.

7. The method of claim 1 wherein processing the received data at the wireless mobile communication device includes discarding the received data if data associated with the at least one of the public utility endpoints is not already stored in the wireless mobile communication device.

8. The method of claim 1 wherein processing the received data at the wireless mobile communication device includes discarding the received data if the at least one of the public utility endpoints is not recognized as a valid endpoint.

9. The method of claim 1 further comprising receiving an acknowledgement from the external, portable computer when the processed data has been properly transferred to the external, portable computer.

10. A public utility data collection system for gathering data from multiple public utility endpoints, wherein the gathered data includes an amount of a utility consumed, the system comprising:
a wireless mobile communication component configured to wirelessly receive data from at least one of the public utility endpoints, the wireless mobile communication component including:
a data processing portion and
a data storage portion,
wherein the data processing portion is capable of comparing data received from the at least one of the public utility endpoints with data stored in the data storage portion; and
an external, portable computing component in local communication with the wireless mobile communication component,
wherein the external, portable computing component includes a data storage component capable of storing received data from the wireless mobile communication component, and
wherein the wireless mobile communication component and the external, portable computing component are configured to be portable as a unit.

11. The public utility data collection system of claim 7 wherein the wireless mobile communication component discards the received data from the at least one of the public utility endpoints if utility consumption data from the at least one of the public utility endpoints has already been received.

12. The public utility data collection system of claim 7 wherein the wireless mobile communication component discards the received data from the at least one of the public utility endpoints if utility consumption data from the at least one of the public utility endpoints has been received less than a predetermined time period earlier.

13. The public utility data collection system of claim 7 wherein the wireless mobile communication component discards the received data from the at least one of the public utility endpoints if data associated with the at least one of the public utility endpoints is not already stored in the data storage portion.

14. The public utility data collection system of claim 7 wherein the wireless mobile communication component discards the received data from the at least one of the public utility endpoints if the at least one of the public utility endpoints is not recognized as a valid endpoint.

15. The public utility data collection system of claim 7 wherein the external, portable computing component sends an acknowledgement to the wireless mobile communication component when the external, portable computing component successfully receives data from the wireless mobile communication component.

16. A mobile data collection system for collecting information from gas, electrical, and/or water utility endpoints, the system comprising:
a remote communication portion configured to wirelessly receive endpoint messages from the endpoints, the remote communication portion including:
a data processing engine having data storage capabilities and data filtering capabilities,
wherein the data filtering capabilities function to discard or cache redundant and/or invalid endpoint messages that are received from the endpoints; and
an external computer portion coupled to the remote communication portion via a communication link,
wherein the external communication portion receives pre-processed endpoint data from the remote communication portion,
wherein the pre-processed endpoint data does not include endpoint messages that have been discarded or cached by the data filtering capabilities of the data processing engine, and
wherein the external communication portion includes a meter reading application that processes the received pre-processed endpoint data.

17. The mobile data collection system of claim 16, wherein the communications link is a wireless link.

18. The mobile data collection system of claim 16, wherein the meter reading application includes processes for maintaining route-related meter reading statistics, providing operating status information, and processing, formatting, and displaying collected data.

19. The mobile data collection system of claim 16, wherein the remote communications portion includes a removable storage device, and wherein the removable storage device includes a database of all utility endpoints within a geographic region.

20. A system for gathering data from multiple public utility endpoints, wherein the gathered data includes an amount of a utility consumed, the system comprising:
means for receiving data from at least one of the public utility endpoints, wherein the data includes indicia identifying the at least one public utility endpoint, wherein the receiving occurs via public utility data collection mean when in radio communication range of the at least one public utility endpoint, and wherein the public utility data collection means includes wireless mobile communication means and portable computer means;
means for processing the received data at the wireless mobile communication means, wherein the indicia identifying the at least one of the public utility endpoints is compared to data stored in the wireless mobile communication means; and
means for transferring the received data from the wireless mobile communication device to the portable computer means if the received data succeeds the comparison.
